(19) United States
(12) Patent Application Publication
(10) Pub. No.: US 2017/0292639 A1
(43) Pub. Date: Oct. 12, 2017

(54) Carbon Fiber Composite Reinforcement With Circumferential And Axial Interlocking

(71) Applicant: Vetco Gray Inc., Houston, TX (US)

(72) Inventors: Jianqiang James Chen, Spring, TX (US); Ronald Ralph Cairo, Houston, TX (US)

(21) Appl. No.: 15/097,020

(22) Filed: Apr. 12, 2016

(51) Int. Cl. F16L 15/00; F16L 9/04

(52) U.S. Cl. CPC F16L 15/006; F16L 9/04

(57) ABSTRACT

A carbon fiber reinforcement for reinforcing a pipe connection between two pipes includes a carbon fiber composite having a substantially circular cross-section, a length, a central axis along the length, an outer surface, and an inner surface, wherein the outer surface of the reinforcement is configured to bond with an inner surface of one of the two pipes. A method for reinforcing a pipe connection between two pipes includes forming a carbon fiber composite reinforcement having a substantially circular cross-section, a length, a central axis along the length, an outer surface, and an inner surface, and bonding the outer surface of the reinforcement to an inner surface of one of the two pipes.

### TECHNICAL FIELD

This invention relates in general to pipe connections in oil and gas production, and in particular to a carbon fiber composite reinforcement for pipe connections in oil and gas production.

### BACKGROUND

In oil and gas production, and more specifically where a riser string or a blow out preventer (BOP) is being connected to a wellhead connector, thread making reduces the thickness and strength of the pipe or casing connections. Low alloy steels have a relatively low strength, for example, around 80 ksi, and a relatively low elastic modulus or stiffness. The nature of the thread results in small notches at the thread roots that can significantly reduce the fatigue capability of the pipe or casing connection due to the introduction of a high stress concentration factor associated with the notches.

FIG. 1, for example, illustrates a sectional perspective view of a pipe connection 100 according to prior art. Pipe connection 100 is formed between a first pipe 10 and a second pipe 40, wherein an external threading 45 on an outer diameter of second pipe 40 corresponds and threads on to an internal threading 15 on an inner diameter of first pipe 10.

Experience has shown that such steel thread connections have limited operation capability and service life without a reinforcing mechanism. Conventional weld-on thread connections that are currently used have a heat affected zone, causing a localized region of material to become brittle, which results in limited strength or fatigue capabilities.

### SUMMARY

One example embodiment is a reinforcement for a pipe connection between two pipes. The reinforcement includes a carbon fiber composite having a substantially circular cross-section, a length, a central axis along the length, an outer surface, and an inner surface, wherein the outer surface of the reinforcement is configured to bond with an inner surface of one of the two pipes.

Another example embodiment is a method for reinforcing a pipe connection between two pipes. The method may include forming a carbon fiber composite reinforcement having a substantially circular cross-section, a length, a central axis along the length, an outer surface, and an inner surface, and bonding the outer surface of the reinforcement to an inner surface of one of the two pipes.

Another example embodiment is a pipe connection including a first pipe having internal threads on an inner surface of the first pipe, a second pipe having external threads on an outer surface of the second pipe, the external threads adapted to engage with the internal threads of the first pipe, and a carbon fiber composite reinforcement having a substantially circular cross-section, a length, a central axis along the length, an outer surface, and an inner surface, wherein the inner surface of the reinforcement is bonded to an outer surface of the first pipe or the outer surface of the reinforcement if bonded to an inner surface of the second pipe.

### BRIEF DESCRIPTION OF THE DRAWINGS

So that the manner in which the features, advantages and objects of the invention, as well as others which will become apparent, are attained and can be understood in more detail, more particular description of the invention briefly summarized above may be had by reference to the embodiment thereof which is illustrated in the appended drawings, which drawings form a part of this specification. It is to be noted, however, that the drawings illustrate only example embodiments of the invention and therefore are not to be considered limiting of its scope as the invention may admit to other equally effective embodiments.

FIG. 1 is a sectional perspective view of a pipe connection according to prior art.

FIG. 2 is a sectional perspective view of a carbon fiber composite reinforcement set for a pipe connection, according to one or more example embodiments of the disclosure.

FIG. 3 is an end view of a carbon fiber composite reinforcement for a pipe connection, according to one or more example embodiments of the disclosure.

FIG. 4 is an end view of a carbon fiber composite reinforcement for a pipe connection, according to one or more example embodiments of the disclosure.

FIG. 5 is a sectional view of a carbon fiber composite reinforcement for a pipe connection, according to one or more embodiments of the disclosure.

FIG. 6 is a sectional perspective view of a carbon fiber composite reinforcement for a pipe connection, according to one or more embodiments of the disclosure.

FIG. 7 is a side view of a carbon fiber composite reinforcement for a pipe connection, according to one or more embodiments of the disclosure.

FIG. 8 is a close-up view of a carbon fiber preform for a composite reinforcement, according to one or more embodiments of the disclosure.

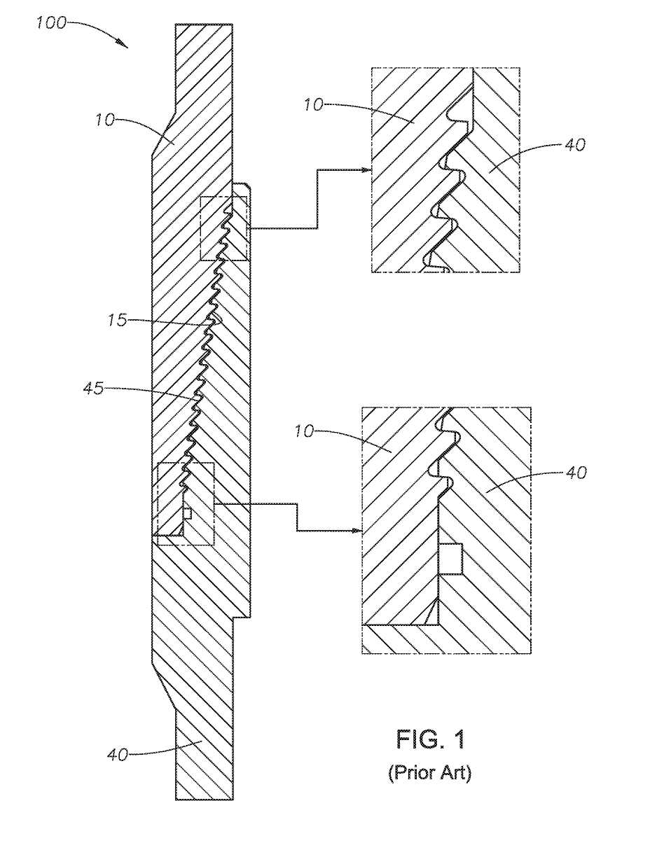

### DETAILED DESCRIPTION

The methods and devices of the present disclosure will now be described more fully hereinafter with reference to the accompanying drawings in which embodiments are shown. The methods and devices of the present disclosure may be in many different forms and should not be construed as limited to the illustrated embodiments set forth herein; rather, these embodiments are provided so that this disclosure will be thorough and complete, and will fully convey its scope to those skilled in the art. Like numbers refer to like elements throughout.

It is to be further understood that the scope of the present disclosure is not limited to the exact details of construction, operation, exact materials, or embodiments shown and described, as modifications and equivalents will be apparent to one skilled in the art. In the drawings and specification, there have been disclosed illustrative embodiments and, although specific terms are employed, they are used in a generic and descriptive sense only and not for the purpose of limitation. Additionally, in the following description, it is understood that such terms as “inner,” “outer,” “upper,” “lower,” “top,” “bottom,” “first,” “second,” and the like are words of convenience and are not to be construed as limiting terms. Moreover, the term “bonding” applied to the composite reinforcement may result from bonding a fully cured section of a composite material, also known as a secondary bond process, or from the “wet layup” process where the composite material is formed into the metal pipe and processed or co-cured or bonded to the metal in a single process.

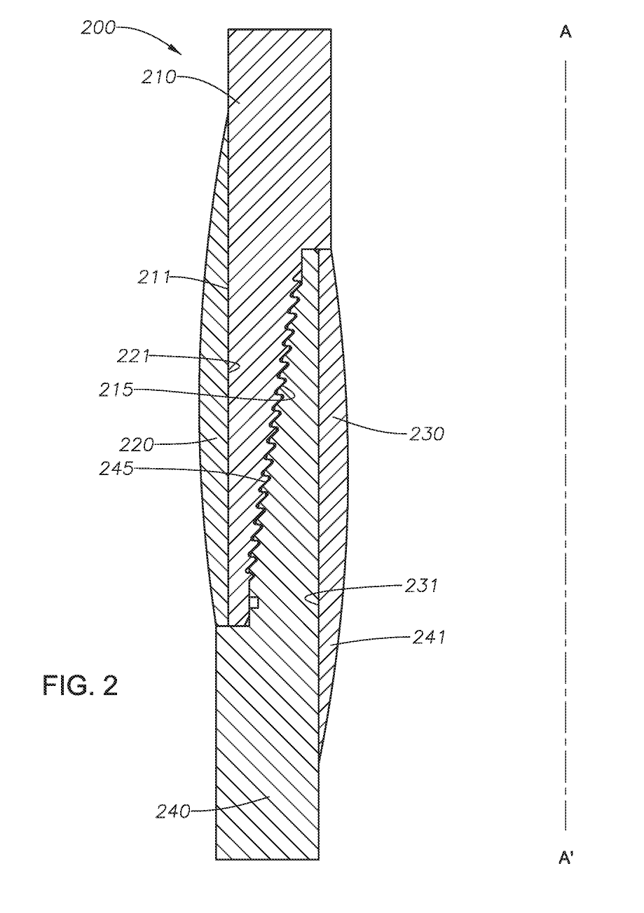

Turning now to the figures, FIG. 2 is a sectional view of a pipe connection 200 between two pipes 210, 240, according to one or more example embodiments. Pipe 210 can have threading 215 formed on an inner surface that correspond with threading 245 formed on an outer surface of pipe 240. Pipes 210, 240 can be threaded together to form a pipe connection 200. According to one example embodiment, reinforcements 220, 230 can be bonded to an outer surface 211 of pipe 210 and inner surface 241 of pipe 240, respectively, to strengthen the pipe connection 200. As illustrated, an inner surface 221 of reinforcement 220 can be bonded to the outer surface 211 of pipe 210, and an outer surface 231 of reinforcement 230 can be bonded to the inner surface 241 of pipe 240.

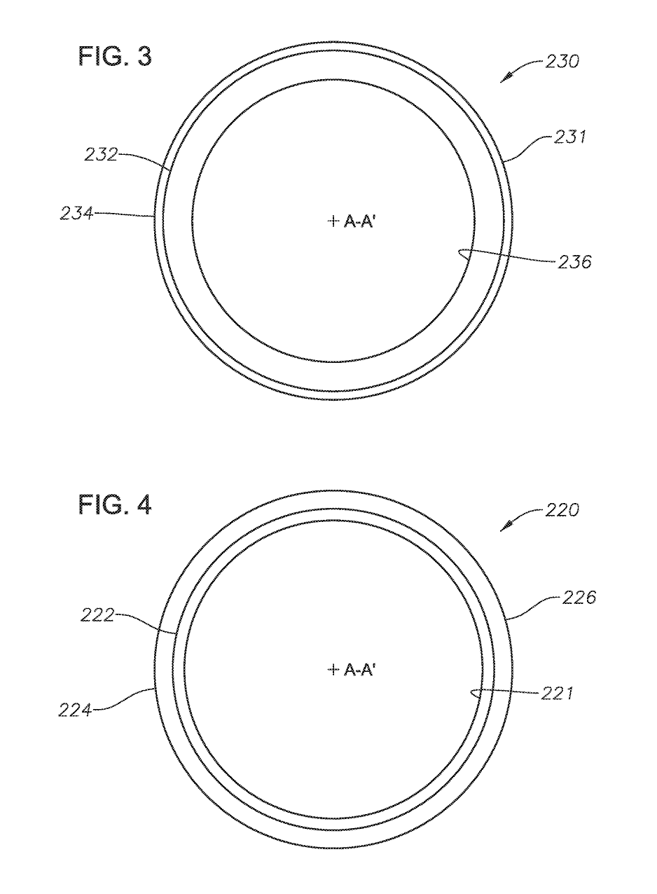

FIG. 3 is an end view of reinforcement 230 for pipe connection 200, according to one or more example embodiments of the disclosure. Reinforcement 230 can include a carbon fiber composite having a substantially circular cross-section, a length, a central axis A-A′ along the length, an outer surface 231, and an inner surface 236. The outer surface 231 of the reinforcement 230 can be configured to bond with an inner surface 241 of pipe 240. In one example embodiment reinforcement 230 may include a first portion 232 having a first cross-sectional thickness and a second portion 234 having a second cross-sectional thickness that is greater than the first cross-sectional thickness. The second portion 234 can be aligned with a high stress location along the inner surface 241 of pipe 240, according to one or more example embodiments. The carbon fiber composite forming reinforcement 230 may include a braided fiber structure including a plurality of carbon fibers. The strength of carbon fibers may range from, for example, 150 ksi to over 600 ksi. When combined with a matrix material, the resulting composite strength may range from, for example, 90 to 360 ksi for a unidirectional material. Structures laminated for off-axis loading may typically provide strength ranging from, for example, 60 to over 200 ksi, which is much higher than the strength of steel. Carbon fiber composite reinforcements, of up to 300 ksi in strength or higher, can significantly strengthen such steel thread connections in these example embodiments. Carbon fiber composites may be designed to have a much higher modulus than steel, and because of their rigidity, the reinforcements can effectively support more flexible steel connection, and reduce the stresses concentrated on the thread notches. The carbon fiber composite reinforcements can be bonded to pipe or casing surface, and thus the process does not result in a heat affected zone. The preforms used for forming the carbon fiber composite reinforcements can be longitudinally and circumferentially braided to balance tension and compression stresses in a longitudinal direction and hoop stress due to internal or external pressures. A larger thickness, as illustrated in FIGS. 2 and 3, can be achieved at high stress areas, such that the arc shape transfers shear stress and normal stress in a controlled fashion to minimize the local stress peaks inherent at the end points of bonded joints.

FIG. 4 is an end view of reinforcement 220 for pipe connection 200, according to one or more example embodiments of the disclosure. Reinforcement 220 can include a carbon fiber composite having a substantially circular cross-section, a length, a central axis A-A′ along the length, an outer surface 226, and an inner surface 221. The inner surface 221 of the reinforcement 220 can be configured to bond with the outer surface 211 of pipe 210. As illustrated, reinforcement 220 may include first portion 222 having a first cross-sectional thickness and a second portion 224 having a second cross-sectional thickness that is greater than the first cross-sectional thickness. The second portion 224 may be aligned, for example, with a high stress location along the outer surface 211 of pipe 210.

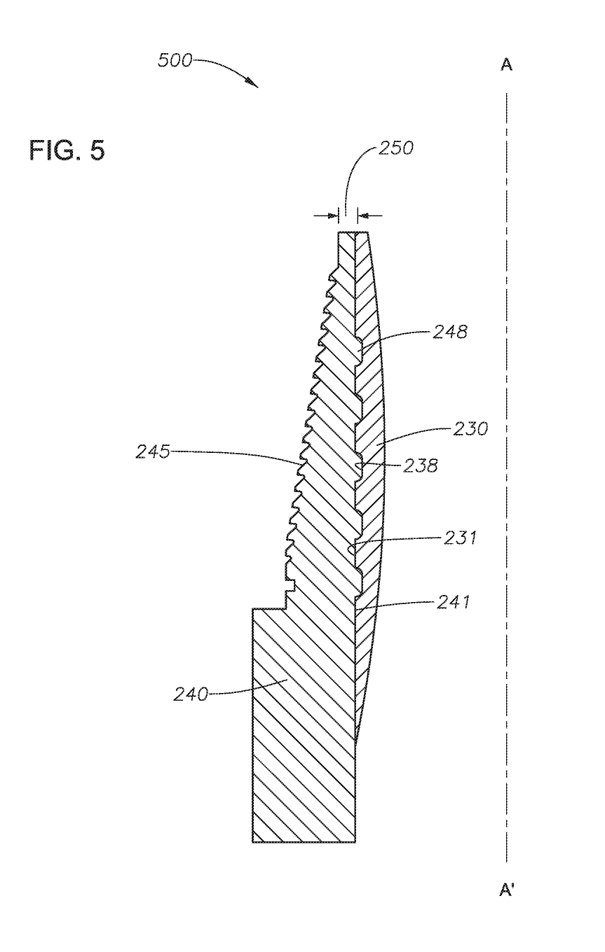

FIG. 5 is a cross-sectional perspective view of a carbon fiber composite reinforcement 230 for a pipe connection 500, according to one or more embodiments of the disclosure. In this example embodiment, the outer surface 231 of the reinforcement 230 is configured to mechanically interlock with an inner surface 241 of pipe 240. In one example, a plurality of mechanical means 238, such as grooves, may be formed on the outer surface 231 of the reinforcement 230 to circumferentially interlock with corresponding mechanical means 248, such as ridges, formed on the inner surface 241 of pipe 240. Although FIG. 5 illustrates the reinforcement 230 has having grooves and pipe 240 as having ridges, the mechanical interlock may be reversed such that the grooves are formed on pipe 240 and ridges are formed on the reinforcement 230. In other words, the interlocking features for redundant load path of composite joint can be formed on the outer diameter or the inner diameter of the reinforcement, and they may include female or male parts, and the pipe may include the corresponding male or female parts, respectively.

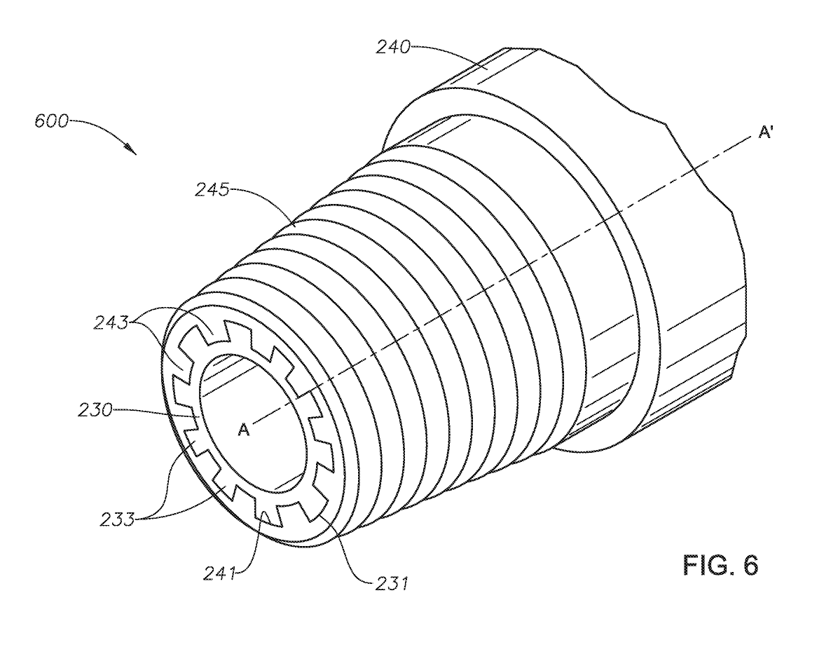

FIG. 6 illustrates a cross-sectional perspective view of a carbon fiber composite reinforcement 230 for a pipe connection 600, according to one or more embodiments of the disclosure. In this example embodiment, a plurality of second mechanical means 233, such as protrusions, are formed along an outer circumference of at least one edge of the reinforcement 230 to axially interlock with corresponding mechanical means 243, such as protrusions, formed along an inner circumference of at least one edge of pipe 240. Similar to reinforcement 230, the inner surface 221 of the reinforcement 220 may be configured to mechanically interlock with an outer surface 211 of pipe 210. Reinforcement 220 may include a plurality of first mechanical means, such as grooves or ridges, formed on the inner surface 221 of the reinforcement 220 to circumferentially interlock with corresponding mechanical means, such as ridges or grooves, formed on the outer surface 211 of pipe 210. In another example embodiment, reinforcement 220 may include a plurality of second mechanical means, such as protrusions, formed along an inner circumference of at least one edge of the reinforcement 220 to axially interlock with corresponding mechanical means, such as protrusions, formed along an outer circumference of at least one edge of pipe 210. Reinforcement 220 can include a carbon fiber composite including a braided structure having a plurality of carbon fibers. The carbon fiber composite can be applied to reinforce thread connectors for improved strength and fatigue capabilities. The reinforcement can be braided longitudinally and circumferentially from a combination of high strength and high modulus carbon fibers to provide focused directional strength and/or stiffness. It can be impregnated, formed, and bonded to the back side of thread connection. The carbon fiber composite reinforcement can be designed for the specific joint with strengths well over 300 ksi in tension and compression. This process does not result in a heat affected zone like current metallurgical joining remedies for threaded joints, which is detrimental to the strength and fatigue capabilities of the parent alloy. The utilization of composite reinforcement improves service life, reliability and the value of the products.

Another example embodiment is a method for reinforcing a pipe connection between two pipes. The method may include forming a carbon fiber composite reinforcement having a substantially circular cross-section, a length, a central axis along the length, an outer surface, and an inner surface, and bonding the outer surface of the reinforcement to an inner surface of one of the two pipes, as illustrated in FIG. 2, for example. The method may also include forming a plurality of first mechanical means on the outer surface of the reinforcement to circumferentially interlock with corresponding mechanical means formed on the inner surface of one of the two pipes, as illustrated in FIG. 5, for example. The method may further include forming a plurality of second mechanical means along an outer circumference of at least one edge of the reinforcement to axially interlock with corresponding mechanical means formed along an inner circumference of at least one edge of one of the two pipes, as illustrated in FIG. 6, for example. The method may also include forming a first portion having a first cross-sectional thickness; and forming a second portion having a second cross-sectional thickness that is greater than the first cross-sectional thickness, wherein the second portion is aligned with a high stress location along the inner surface of one of the two pipes, as illustrated in FIGS. 3 and 4, for example.

The method may also include forming a braided structure including a plurality of carbon fibers. Longitudinally and circumferentially cross braided carbon fiber composites can effectively reinforce the pipe connection by providing a redundant load path that reduces the tension or compression and hoop stresses on the steel threads. Carbon fiber composites can also have a much higher elastic modulus than steel by interspersing high-modulus fibers among the high strength fibers. This can be done globally or very locally for a strategic reinforcement. The enhanced stiffness and rigidity provides a firm foundation to effectively support or reinforce flexible steel and minimize the stresses in the thread notches. The reinforcement may be braided, although other modalities are possible, and formed such that it presents a large cross-section thickness aligned with the high stress location, and has an arcuate shape (on the posterior, non-bonded, side). Mechanical interlocking features can be incorporated into the mating surface of the steel to provide enhanced load transfer (rather than pure shear) from the steel to the composite.

The carbon fiber composite reinforcement described in the above example embodiments may be braided using techniques commonly known in the art, including but not limited to 3D braiding. Alternatively, the composite reinforcement may be woven using warp and weft fibers or yarns, which may be made of any material suitable for the purpose, or any material which exhibits the desired physical, thermal, and/or chemical properties. Carbon, nylon, rayon, glass fiber, ceramic, aramid, polyester, and metal yarns or fibers are but a few examples. The fibers may be dispensed in a “tow” format that includes various numbers of individual fibers. Typical tows, for example, may contain from 2000 to 12000 individual fibers. The tows are the working media for woven, braided, or tape forms of fibers that are eventually combined with a matrix media to form the composite material/structure. While flat multifilament yarns are preferred as the precursor, yarns or fibers of any form may be used, e.g. monofilaments, flat monofilaments, multifilament yarns, textured multifilament yarns, twisted multifilament yarns, braided structures, or combinations thereof. Each of the yarn components or fibers may be “sized” or coated with one or more layers of a coating, for example, a finish or any other coating that may enhance the performance of the component fibers, if required.

The fiber preforms used for forming the carbon fiber composite reinforcement can be a single layer weave or a multilayer weave fabric woven using any convenient pattern for the warp fiber, i.e., ply-to-ply, through thickness angle interlock, orthogonal, etc. While a plain weave is preferred for the structure, the preform can be woven using practically any conventional weave pattern, such as plain, twill, harness satin etc. Similarly, while carbon fiber is preferred, the invention is applicable to practically any other fiber type.

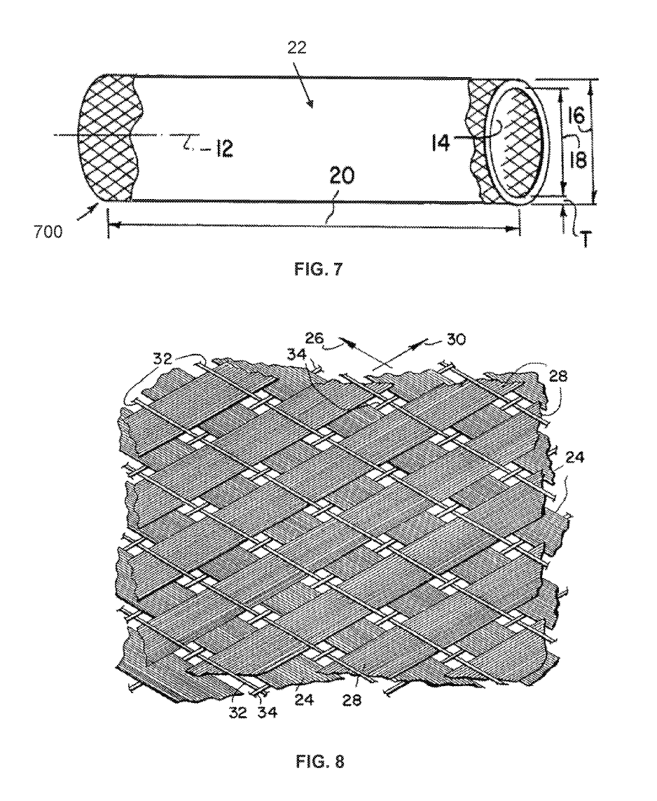

One example of a fiber preform is illustrated in FIG. 7, for example. As used in the specification and claims herein, the term “strand” includes a single fiber or filament or thread as well as a bundle of fibers or filaments or threads. Each of the following, whether twisted or untwisted, is a strand: a fiber, a filament, a yarn, a tow, and a thread. With reference to FIG. 7, there is-shown schematically a biaxial braided structure 700 having a longitudinal axis 12 and a hollow interior 14. The structure 700 is biaxially braided as will be described herein. The structure 700 may be partially or completely impregnated in a resin matrix 22. The braided fabric structure 700 has schematically a fabric thickness T and has an outer diameter 16 and an inner diameter 18 and a length 20.

With reference to FIG. 8, there is shown partially schematically an enlarged view of a portion of the braided fabric of FIG. 7; the strands 28 form the outside surface or layer of the cylindrical structure 700 and the strands 24 form the inside surface or layer of the structure 700. In FIG. 8 the strands are shown somewhat spaced apart for clarity of illustration; preferably they are closer together eliminating the air spaces shown. When the structure is considered as a whole, it can be seen that the fabric or sleeve is braided in a diamond braid (over one, under one). However, all the strands going in a single biaxial direction are not the same. The biaxially braided fabric has a plurality of first performance strands 28 and third containment strands 34 extending parallel to one another and helically in a first direction 30 and a plurality of second performance strands 24 and fourth containment strands 32 extending parallel to one another and helically in a second direction 26. The first, second, third, and fourth strands are braided together in a diamond braid style. As shown in FIG. 8, between every two first strands 28 is a third strand 34 and between every two third strands 34 is a first strand 28, that is, they alternate. The second strands 24 and fourth strands 32 alternate in the same manner. The fiber preform structure illustrated in FIGS. 7 and 8 are just examples, and any fiber structure or form may be used to form the fiber reinforcement. Additionally, placing axial tows in a post-braiding operation are an option should additional axial strength or stiffness be required of the biaxially braided structure.

After the fiber preforms are formed using any of the above example methods, the preforms may be processed into a reinforced composite by impregnating the preform with a matrix material, such as for example, epoxy, bismaleimide, polyester, vinyl-ester, ceramic, and carbon, using any conventional resin infusion method, such as, for example, resin transfer molding, chemical vapor filtration, wet layup or resin film infusion, thereby forming a three dimensional composite structure. In one embodiment, reinforcements 220, 230 can be employed in a drilling riser in order to support a riser string and blow out preventer (BOP) from a drillship or platform until or after it can be connected to the wellhead connector on the surface of the sea. In another embodiment, reinforcements 220, 230 can be employed in a well access system, connecting the top tensioned riser to the subsea wellhead. Such a well access system may include hydraulic cylinder, and may be utilized, for example, by a direct vertical access (DVA) system, a completion workover riser (CWOR) system, a riserless light well intervention (RLWI) system, a gate spider, or the like.

In yet another embodiment, reinforcements 220, 230 can be employed in a wellhead connection, such as a connection associated with a stress joint of a connector assembly that engages in the upper rim of the wellhead housing. Reinforcements 220, 230 can also be employed, for example, in jack-up rigs, spars, drillships, dynamically positioned floating drilling systems, and moored floating drilling systems. A running tool that implements reinforcements 220, 230 may alternatively be employed in a drill string, for example, a tool joint, a drill collar, a telescoping joint, a riser joint, a riser joint with buoyancy, a fill-up valve, or a termination spool.

In yet another embodiment, reinforcements 220, 230 can be utilized in applications other than in running tool, including but not limited to, construction equipment, manufacturing machinery, excavators, machine linkages, and wheel bulldozers. Reinforcements 220, 230 may be used in a hydraulic actuator application, including but not limited to, an aerial work platform, a crane, an earth moving machine, a wind mill, and in solar tracking equipment.

The devices and methods described herein, therefore, are well adapted to carry out the objects and attain the ends and advantages mentioned, as well as others inherent therein. While example embodiments of the devices and methods have been given for purposes of disclosure, numerous changes exist in the details of procedures for accomplishing the desired results. These and other similar modifications will readily suggest themselves to those skilled in the art, and are intended to be encompassed within the spirit of the devices and methods disclosed herein and the scope of the appended claims.

1. A reinforcement for a pipe connection between two pipes, the reinforcement comprising:
a carbon fiber composite having a substantially circular cross-section, a length, a central axis along the length, an outer surface, and an inner surface, wherein the outer surface of the reinforcement is configured to bond with an inner surface of one of the two pipes.

2. The reinforcement of claim 1, wherein the outer surface of the reinforcement is configured to mechanically interlock with an inner surface of one of the two pipes.

3. The reinforcement of claim 1, further comprising a plurality of first mechanical means formed on the outer surface of the reinforcement to circumferentially interlock with corresponding mechanical means formed on the inner surface of one of the two pipes.

4. The reinforcement of claim 3, wherein the plurality of first mechanical means comprise ridges, grooves, or protrusions.

5. The reinforcement of claim 1, further comprising a plurality of second mechanical means formed along an outer circumference of at least one edge of the reinforcement to axially interlock with corresponding mechanical means formed along an inner circumference of at least one edge of one of the two pipes.

6. The reinforcement of claim 5, wherein the plurality of second mechanical means comprise protrusions.

7. The reinforcement of claim 1, further comprising a first portion having a first cross-sectional thickness and a second portion having a second cross-sectional thickness that is greater than the first cross-sectional thickness, wherein the second portion is aligned with a high stress location along the inner surface of one of the two pipes.

8. The reinforcement of claim 1, wherein the carbon fiber composite comprises a braided structure comprising a plurality of carbon fibers.

9. A method for reinforcing a pipe connection between two pipes, the method comprising:
forming a carbon fiber composite reinforcement having a substantially circular cross-section, a length, a central axis along the length, an outer surface, and an inner surface; and
bonding the outer surface of the reinforcement to an inner surface of one of the two pipes.

10. The method of claim 9, further comprising:
forming a plurality of first mechanical means on the outer surface of the reinforcement to circumferentially interlock with corresponding mechanical means formed on the inner surface of one of the two pipes.

11. The method of claim 9, further comprising:
forming a plurality of second mechanical means along an outer circumference of at least one edge of the reinforcement to axially interlock with corresponding mechanical means formed along an inner circumference of at least one edge of one of the two pipes.

12. The method of claim 9, further comprising:
forming a first portion having a first cross-sectional thickness; and
forming a second portion having a second cross-sectional thickness that is greater than the first cross-sectional thickness, wherein the second portion is aligned with a high stress location along the inner surface of one of the two pipes.

13. The method of claim 9, further comprising:
forming a braided structure comprising a plurality of carbon fibers;
impregnating the braided structure in a resin; and
curing the impregnated braided structure to form the carbon fiber composite reinforcement.

14. A pipe connection comprising:
a first pipe having internal threads on an inner surface of the first pipe;
a second pipe having external threads on an outer surface of the second pipe, the external threads adapted to engage with the internal threads of the first pipe; and
a carbon fiber composite reinforcement having a substantially circular cross-section, a length, a central axis along the length, an outer surface, and an inner surface, wherein the inner surface of the reinforcement is bonded to an outer surface of the first pipe or the outer surface of the reinforcement if bonded to an inner surface of the second pipe.

15. The pipe connection of claim 14, wherein the inner surface of the reinforcement is configured to mechanically interlock with the outer surface of the first pipe.

16. The pipe connection of claim 14, wherein the reinforcement comprises a plurality of first mechanical means formed on the inner surface of the reinforcement to circumferentially interlock with corresponding mechanical means formed on the outer surface of the first pipe.

17. The pipe connection of claim 16, wherein the plurality of first mechanical means comprise ridges, grooves, or protrusions.

18. The pipe connection of claim 14, wherein the reinforcement comprises a plurality of second mechanical means formed along an inner circumference of at least one edge of the reinforcement to axially interlock with corresponding mechanical means formed along an outer circumference of at least one edge of the first pipe.

19. The pipe connection of claim 14, wherein the reinforcement comprises a first portion having a first cross-sectional thickness and a second portion having a second cross-sectional thickness that is greater than the first cross-sectional thickness.

20. The pipe connection of claim 14, wherein the carbon fiber composite comprises a braided structure comprising a plurality of carbon fibers.
